(19) United States
(12) Patent Application Publication
(10) Pub. No.: US 2026/0258990 A1
(43) Pub. Date: Sep. 3, 2026

(54) VALVE DEVICE FOR OPERATION WITH A REFRIGERANT

(71) Applicant: Hanon Systems, Daejeon (KR)

(72) Inventors: Carsten Ohrem, Bergheim (DE); Daniel Zens, Kreuzau (DE); Michael Schlattmann, Köln (DE); Andreas Capelle, Pulheim (DE); Deny Laforge, Kerpen (DE)

(21) Appl. No.: 18/993,329

(22) PCT Filed: Jul. 10, 2023
(86) PCT No.: PCT/KR2023/009732

§ 371 Date: Jan. 10, 2025

(30) Foreign Application Priority Data
Jul. 14, 2022 (DE) 10 2022 117 626.6
Jun. 30, 2023 (DE) 10 2023 117 367.7

(51) Int. Cl. F25B 41/35; F25B 9/00; F25B 41/38

(52) U.S. Cl. CPC F25B 41/35; F25B 9/008; F25B 41/38

(57) ABSTRACT

A valve device for operation with a refrigerant having a valve body bushing with a first axial section provided for insertion into a valve block, in which a valve body chamber with a valve needle guided axially therein is formed, a spindle drive with a magnetized rotor shaft, which is supported by an anti-friction bearing and coupled to the valve needle wherein a rotation of the rotor shaft causes an axial movement of the valve needle in the valve body bushing, and a capsule element which is open on one side, in which the spindle drive and a second axial section of the valve body bushing are received, wherein the capsule element can be fastened to the valve block by an actuator receiving it for driving the rotor shaft wherein the first axial section is received in the valve block in a fluid-tight manner.

### TECHNICAL FIELD

The invention relates to a valve device for operation with a refrigerant, in particular for operation in a heat pump system of a motor vehicle air conditioning system, in which carbon dioxide, CO2 (R744) or 2,3,3,3-tetrafluoropropene (R1234yf) is used as refrigerant.

### BACKGROUND ART

In contrast to vehicles with a classic internal combustion engine, no comparable continuous heat source for vehicle air conditioning is available in electric vehicles. In order to control the temperature of vehicles operated purely electrically, it is therefore necessary to make use of the available electrical energy, which in the case of vehicles operated with battery power entails a considerable reduction in the vehicle range, in particular when large temperature differences have to be overcome. Compared to conventional electric heaters, heat pump systems with a refrigerant circuit contribute to an improved utilisation of the available electrical energy. Bi-directional operation of such systems enables heating in winter and cooling in summer. Heat pump systems which can be operated with carbon dioxide (R744) as a refrigerant are particularly preferred, since R744 has a very low global warming potential. However, the operation of heat pump systems with R744 as a refrigerant is associated with increased design requirements, since larger or more robust components are required due to higher operating pressures. Thus, high pressures on control elements, in particular bidirectional valves, require correspondingly high movement forces which can only be handled by actuators with greater power.

A measure for reducing high movement forces on valve devices is based on the utilisation of counter-pressure devices. From DE 10 2016 013 492 A1, a valve is known which can be operated bidirectionally and in which a system back pressure is utilised to assist in order to permit lower effort for moving the control element. The valve known from DE 10 2016 013 492 A1 is a combined expansion shut-off valve which, in a closed state, has a pressure bypass to a valve chamber in which the valve needle is guided. The pressure bypass causes a pressure balance which reduces the pressure forces required for valve needle adjustment. Comparatively large flow diameters can be ensured between the media accesses of the valve in two flow directions. The valve advantageously permits a bidirectional refrigerant flow and the function of an expansion valve in respectively opposite directions.

In the motor vehicle sector, compact solutions are preferred, with the result that usually several valves are accommodated arranged in a narrow space in a common valve block or valve module for influencing flow paths. For example, up to eight valves of a heat pump system can be assembled in a valve block. Until now, individual valve components, in particular sealing seats with seals, have been designed directly within the valve block or are located in the valve block. These separately designed valve components cooperate only in the assembled state with further components of the valve as a functional unit. However, this entails the disadvantage that in the case of maintenance or in the case of an exchange of an individual valve, the entire valve block arrangement must be disassembled, since maintenance of individual valve units is made more difficult due to the compact construction. Furthermore, it has been found that valves of the currently known design have a comparatively high hysteresis in the flow curve, which can have a disadvantageous effect on the operating process. Finally, there is further need for improvement with regard to the construction of valves for heat pump systems in motor vehicles also due to the comparatively high leakage potential, in particular when R744 refrigerant is used.

### DISCLOSURE OF INVENTION

### Technical Problem

The object of the invention is thus to propose a valve device for operation with a refrigerant, in particular for operation with carbon dioxide (CO2 (R744)), in a heat pump system of a motor vehicle, with which disadvantages known from the prior art can be reduced or avoided.

### Solution to Problem

According to the concept of the invention, the substantial components of the valve device are received by a capsule element or integrated in this capsule element, so that the valve device is formed as a complete functional unit without separately assembled valve components being required in the valve block. The valve device according to the invention can advantageously be assembled or disassembled individually without the need for replacing the entire valve block or valve module. In the context of the invention, a valve block or valve module is to be understood as meaning a body which receives several valves or valve devices and has several connections and channels with which fluid flows are regulated. For the sake of simplicity, the term valve block is uniformly used below. The valve device is provided for operation with a refrigerant, in particular for operation with a refrigerant in a motor vehicle heat pump system.

The valve device according to the invention has a valve body bushing with a first axial section provided for insertion into a valve block. This axial first section of the valve body bushing is received in the valve block. A valve body chamber with a valve needle guided axially therein is formed inside the valve body bushing. As a further valve component, the valve device according to the invention comprises a spindle drive with a magnetised rotor shaft which is supported by an anti-friction bearing and coupled to the valve needle in such a way that a rotation of the rotor shaft causes an axial movement of the valve needle in the valve body bushing. The axial movement causes the valve device to open or close, depending on the direction in which the rotor shaft rotates. Furthermore, the valve device according to the invention comprises a capsule element which is open on one side and in which the spindle drive and a second axial section of the valve body bushing are received, wherein the capsule element can be fastened to the valve module by means of an actuator which receives it for driving the rotor shaft in such a way that the first axial section is received in the valve block in a fluid-tight manner.

The opening of the capsule element can have a stepped edge in the form of a radially outwardly pointing collar which, for fastening the capsule element, interacts with a sleeve element which is bearing on or is supported on the collar. Various means, for example clamping means, snap means or screw connections, can be used for fastening the sleeve element which is guided over the capsule element. With the help of the fastening means, the collar end face is pressed against the opposite valve block surface for sealing the valve components received in the capsule element.

According to a particularly preferred design of the valve device according to the invention, which is provided in particular for use with the refrigerant R744, it is advantageous if a threaded ring is used as the sleeve element. The threaded ring is formed in the form of a cylinder ring with an opening through which the capsule element is guided and is thereby received by the threaded ring. In doing so, the threaded ring bears with its side facing the valve block on the capsule element collar. On the radial outer surface, the threaded ring has an external thread for screwing into the valve block. In order to fasten the capsule element, the threaded ring is guided over the capsule element and, supported on the collar of the capsule element, can be screwed to an internal thread formed in the valve block. In this case, a seal, preferably a metal bead seal, is arranged between the end face of the capsule element collar, which is formed in the axial direction, and the valve block or an end face of the valve block, which faces the end face of the capsule element collar. Furthermore, the threaded ring has engagement means for a tool in order to screw the threaded ring to the valve block using the tool. The engagement means for the tool can be formed axially and/or radially on the threaded ring. For example, the threaded ring can have a toothed ring as engagement means. By means of a screw connection with the threaded ring in the valve block, a defined contact pressure can be generated, which in combination with the metal bead seal contributes to a particularly good sealing. The use of a metal bead seal advantageously reduces the risk of leakage. This is advantageous in heat pump systems which must operate at high operating pressures due to the use of R744 as a refrigerant.

According to another advantageous design of the valve device according to the invention, which is preferably provided for operation with refrigerant, the refrigerant 2,3,3,3-tetrafluoropropene (R1234yf) or the refrigerant dichlorotrifluoroethane (R134a), a fastening plate can be used as the sleeve element, which is guided over the capsule element for fastening the capsule element and can be fastened to the valve block in a manner supported on the collar of the capsule element. The fastening plate thus has at least one opening, so that the fastening plate can receive the capsule element, wherein the cross-section of this opening is designed such that the fastening plate bears on the collar of the capsule element. On the side facing the valve block, the fastening plate can have a support stub through which the at least one opening is formed. The end face of the support stub is formed to bear on the capsule element collar. The support stub can also have a collar which is directed radially outwards and whose collar end face preferably bears on the capsule element collar in a form-fitting manner. The fastening plate can furthermore have at least two screw passages through which screws can be screwed into the valve block, wherein a contact pressure is exerted on the fastening plate bearing on or supported on the capsule element collar.

A corrosion protection element in the form of an O-ring can be arranged between the fastening plate and the valve module. This O-ring can be arranged at the shank end of the support stub of the fastening plate.

For the actuator, the fastening plate preferably serves as a limit and as a holder. For the joint fastening of the actuator and of the capsule element, the actuator can also have screw passages which correspond to the screw passages of the fastening plate, so that screws can be screwed into the valve block receiving the valve device through the screw passages of the actuator and through the screw passages of the fastening plate. In this way, the capsule element with the valve components arranged therein and the actuator can simultaneously be fastened together to the valve block.

The anti-friction bearing, which receives and supports the rotor shaft of the spindle drive within the valve body bushing, can be formed as a ball bearing or as a roller bearing. According to an advantageous design, the anti-friction bearing is received in the valve body bushing in the region of the second axial section and is preferably fixed in the valve body bushing by an edge flanging. For the sake of simplicity, an edge flanging of the upper edge of the valve body bushing can be formed for fixing the anti-friction bearing at specific positions, for example at two, three or four positions. Due to the reduced frictional resistance, the rotation of the rotor shaft is absorbed by the anti-friction bearing in a more smooth-running manner, so that overall less driving force has to be expended. The friction resistance reduced by the anti-friction bearing advantageously contributes to a reduction in the flow hysteresis.

In order to further stabilise the bearing of the rotor shaft, a sliding bearing can additionally be received in the capsule element. The sliding bearing can preferably be positioned on the capsule element bottom, wherein a shank end or a pin of the rotor shaft is received by the sliding bearing. Further, it can be provided for the sliding bearing to be formed as an integral part of the capsule element.

The second section of the valve body bushing can be inserted axially into the capsule element to such an extent that only the first axial section of the valve body bushing provided for insertion into the valve module projects out of the capsule element. For this purpose, the valve body bushing can have a stop rib formed on the outer circumference. Inserted into the capsule element, the stop rib ensures a correct and accurate positioning of the valve body bushing in the capsule element and thereby limits the axial insertion depth of the second section of the valve body bushing. The stop rib forms a lip which can radially merge into the end face of the collar at the capsule element opening. In this way, a sealing effect with respect to the capsule element is ensured. Preferably, the outer diameter of the valve body bushing corresponds to the inner diameter of the capsule element.

The valve needle guided in the valve body bushing and movable axially back and forth can have at least one groove running around the outer circumference with a seal for internal sealing with respect to the valve body bushing. This seal, which can also be referred to as a valve needle seal, is formed in particular for use of the valve device with the refrigerant R744 as a combination seal with an O-ring and an outwardly pointing polytetrafluoroethylene (PTFE)-ring arranged on the O-ring.

In the first section, preferably in the region of the head end, the valve body bushing can have at least one groove running around the outer circumference with a seal for internal sealing with respect to the valve block. This seal is preferably formed as a sealing ring or O-ring. Furthermore, it can be provided that the valve body bushing has different shank diameters in the first section, wherein each shank diameter has at least one groove running around the outer circumference with a seal for internal sealing with respect to the valve block. According to one design of the valve device according to the invention, which is provided in particular for operation with the refrigerant R1234yf or the refrigerant R134a, the valve body bushing in the second axial section, which is inserted into the capsule element, can have at least one groove running around the outer circumference with a seal for internal sealing with respect to the capsule element.

The valve needle can have a circular cylindrical shape in some regions, wherein the receipt in the valve body bushing is also formed in a circular cylindrical manner. At least the upper shank end of the valve needle can have a recess which corresponds to a cross-sectional geometry of the valve body bushing in order to avoid rotation. The cross-sectional geometry of the valve body bushing forms a guide for the valve needle. Alternatively, the use of a guide disc can be provided, which is pressed into the valve body bushing. The guide disc has an opening cross-section corresponding to the cross-sectional geometry of the upper shank end of the valve needle, which prevents rotation of the valve needle. Thus, a guide disc can be pressed into the valve body bushing, wherein the guide disc has an opening cross-section which receives the valve needle and guides the valve needle axially. The use of a guide disc proves to be advantageous with regard to the assembly of the valve needle within the valve body bushing, since the valve needle is first positioned in the valve body bushing and the guide disc is subsequently pressed into the valve body bushing.

For further sealing, a seal in the form of a sealing ring can be arranged between the capsule element and the actuator.

The valve body bushing and the valve needle can be formed in such a way that, in a closed state of the valve device, there is a pressure bypass to the valve body chamber. In this case, the free diameter for pressure equalisation in the pressure bypass can be increased, in particular when the refrigerant R744 is used. The dimensioning of the free diameters of the pressure bypass required for providing the pressure balance is orientated on the refrigerant used and the dimensioning of the valve device.

It can be provided that the valve needle diameter for use with the refrigerant R744 is dimensioned smaller than for use with the refrigerants R1234yf or R134a.

The substantial advantage of the valve device according to the invention is that all the valve components required for valve operation are brought together in a common component arrangement received by the capsule element. Thus, no valve components remain in the valve block. The valve device according to the invention can thus be completely assembled and disassembled as a functional unit. This is also advantageous for maintenance, since it is not necessary to disassemble the entire valve block. The additional realisation of a pressure compensation system with the help of the pressure bypass reduces the required movement forces, so that the actuator component can be embodied to be smaller in dimension. Thus, the pressure compensation relieves the valve device, which increases the robustness of the system as a whole.

The invention is intended for operation with a refrigerant, in particular for operation in a heat pump system of a motor vehicle air conditioning system in which carbon dioxide (CO2 (R744)) or 2,3,3,3 tetrafluoropropene (R1234yf) is used as refrigerant.

### BRIEF DESCRIPTION OF DRAWINGS

Further details, features and advantages of designs of the invention will become apparent from the following description of exemplary embodiments with reference to the associated drawings. Wherein:

FIG. 1: shows a schematic sectional representation of an exemplary embodiment of the valve device according to the invention,

FIG. 2: shows a schematic representation of an exemplary embodiment of a valve needle of the valve device according to the invention in a perspective view,

FIG. 3a: shows a schematic representation of a perspective view of a combination of rotor shaft and valve body bushing of the valve device according to the invention,

FIG. 3b: shows a schematic representation of a metal bead seal,

FIG. 3c: shows a schematic representation of a guide disc of the valve device according to the invention,

FIG. 4: shows a schematic sectional representation of the interaction of the capsule element of the valve device according to the invention with a valve block,

FIGS. 5a-5l: show assembly steps for the assembly of the valve device according to the invention,

FIG. 6a: shows a schematic representation of a design of the valve device according to the invention in the assembled state without an actuator,

FIG. 6b: shows the design of the valve device according to the invention with an actuator shown in FIG. 6a,

FIG. 6c: shows a schematic sectional representation of the design of the valve device according to the invention shown in FIG. 6a,

FIG. 7: shows a schematic sectional representation of the valve device according to the invention of the components of the capsule element and the valve body bushing in operative connection with a valve block, and

FIGS. 8a-8n: show assembly steps for the assembly of the design of the valve device according to the invention shown in FIG. 6a.

Recurring features are identified by the same reference numerals in the figures.

### MODE FOR THE INVENTION

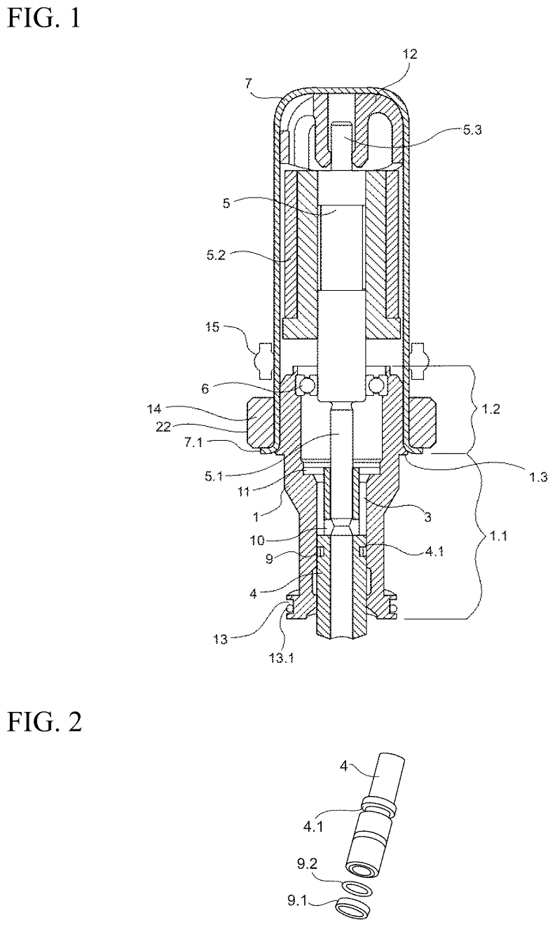

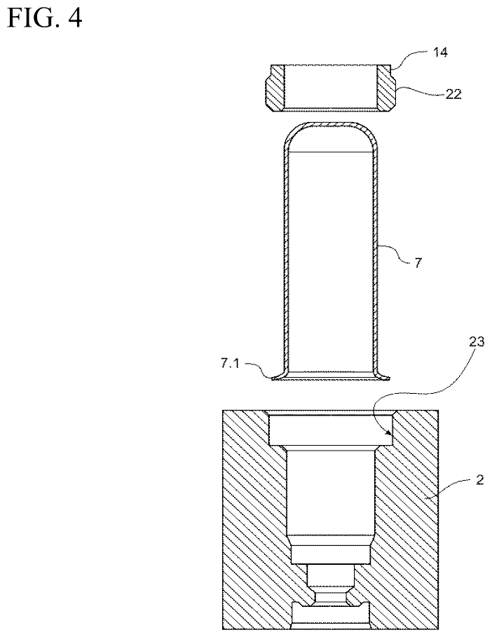

FIG. 1 shows a schematic sectional representation of an exemplary embodiment of the valve device according to the invention for operation with the refrigerant R744. The valve device comprises a valve body bushing 1 in which a valve body chamber 3 with a valve needle 4 guided axially therein is formed. A first axial section 1.1 of the valve body bushing 1 is provided for insertion into a valve block 2 (see FIG. 4). A second axial section 1.2 of the valve body bushing 1 is received inserted in a capsule element 7. The axial insertion depth of the valve body bushing 1 is limited by a stop rib 1.3 formed on the outer circumference of the valve body bushing 1. This stop rib 1.3 forms a common contact surface with a stepped edge formed on the capsule element 7 in the form of a radially outwardly pointing collar 7.1. Furthermore, a spindle drive with a magnetised rotor shaft 5 is received in the capsule element 7, which is supported by an anti-friction bearing 6 in the form of a ball bearing positioned in the valve body bushing 1. The rotor shaft 5 has a threaded shank 5.1 which is screwed into an internal thread of the valve needle 4 so that a rotation of the rotor shaft 5 causes an axial movement of the valve needle 4 guided in the valve body bushing 1. The rotation of the rotor shaft 5 is generated by a magnetic actuator (not shown) which receives the capsule element 7. For this purpose, the rotor shaft 5 is injection-moulded with a magnet 5.2. A sliding bearing 12 is arranged on the capsule element bottom of the capsule element 7. This sliding bearing supports a pin 5.3 of the rotor shaft 5.

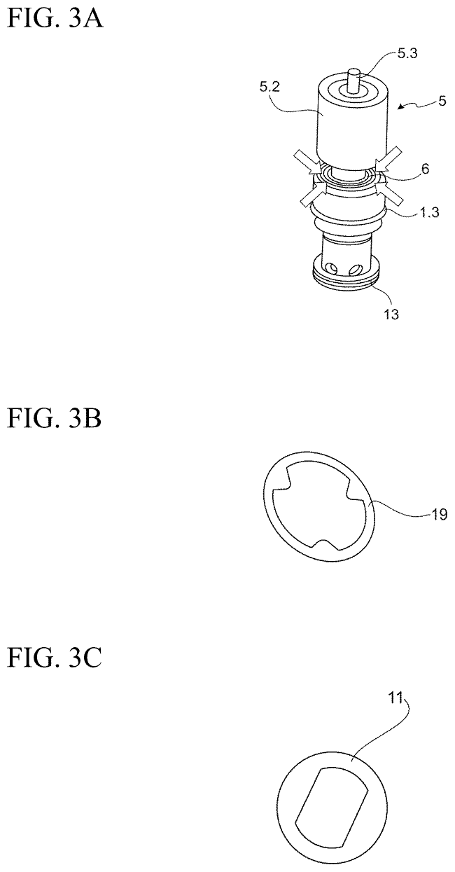

The valve device is fastened to the valve block 2 (FIG. 4) by means of a threaded ring 14 which has an external thread 22. For fastening the capsule element 7, the threaded ring 14 is guided over the capsule element 7 so that it can be screwed, supported on the capsule element collar 7.1, to an internal thread 23 formed in the valve block 2. For sealing purposes, a metal bead seal 19 as represented in FIG. 3b is arranged between an end face of the capsule element collar 7.1 formed in the axial direction of the capsule element 7 and the valve block 2.

The valve needle 4 has radial perforations 10 which form a pressure bypass to the valve body chamber 3. To avoid rotation of the valve needle 4 within the valve body bushing 1, a guide disc 11 is pressed into the valve body bushing 1. A possible design of the guide disc 11 is explained in greater detail in FIG. 3c. Furthermore, the valve needle 4 has a groove 4.1 formed on the outer circumference with a combination seal 9, which is explained in greater detail in FIG. 2, in which the valve needle 4 is represented separately. A further seal 13.1 is arranged at the head end of the valve body bushing 1 in a groove 13 located there on the outer circumference. The seal 13.1 is formed as an O-ring. The first axial section 1.1 of the valve body bushing 1 forms a shank with different diameters, wherein a shank centre part tapering towards the shank centre has a smaller diameter than the head end of the valve body bushing 1 which has the groove 13 with the seal 13.1.

For sealing the capsule element 7 relative to that of the receiving actuator 8 (see FIG. 51), an arrangement of a sealing ring 15 is provided on the outer circumference of the capsule element 7. This surrounding sealing ring 15 can also be referred to as an actuator seal.

FIG. 2 shows a schematic representation of an exemplary embodiment of a valve needle 4 of the valve device according to the invention in a perspective view. The valve needle 4 represented in FIG. 2 is provided in particular for use in a valve device for operation with the refrigerant R744. On the outer circumference, the valve needle 4 has a groove 4.1 which receives a combination seal 9. The combination seal 9 comprises two components, a PTFE-ring 9.1 and an O-ring 9.2, wherein the PTFE-ring is arranged as a sliding seal within the groove 4.1 above the O-ring 9.2, so that the PTFE-ring 9.1 is directed radially outwards.

FIG. 3a shows a schematic representation of a perspective view of a combination of the rotor shaft 5 and the valve body bushing 1 of the valve device according to the invention. The rotor shaft 5 has a magnet 5.2 for driving the rotor shaft 5. At the upper end, a pin 5.3 is formed for receipt in the sliding bearing 12 of the capsule element 7. The ball bearing 6 supporting the rotor shaft 5 is pressed into the valve body bushing 1, wherein a fixation of the ball bearing 6 within the valve body bushing 1 is realised by a flanging of the upper edge of the valve body bushing 1 at the arrow positions.

FIG. 3b shows a design of a metal bead seal 19, such as is used for sealing between the end face of the capsule element collar 7.1 of the capsule element 7 and the valve block surface, in order to ensure a fluid-tight sealing of the valve device with respect to the environment. In the example shown, the metal bead seal 19 has three lugs for fixation, wherein more or less fixing lugs are conceivable. Surface imperfections can advantageously be compensated for by the use of the metal bead seal 19, as a result of which improved sealing can be ensured.

In FIG. 3c, a design of the guide disc 11 is shown which is press-fit in order to avoid rotation and to enable axial guidance of the valve needle 4 within the valve body bushing 1. The opening cross-section of the guide disc 11 corresponds to the geometric design of the upper shank of the valve needle 4. The corresponding geometries prevent a rotation of the valve needle 4 within the cylindrically formed valve body bushing 1, so that the rotation of the threaded shank 5.1 of the rotor shaft 5 merely causes an axial movement of the valve needle 4 within the valve body bushing 1.

FIG. 4 shows a schematic sectional representation of the interaction of the capsule element 7 of the valve device according to the invention with a valve block 2 in a design with a screw connection for fastening the capsule element 7 to the valve block 2. For better illustration, the further components of the valve device are not represented in FIG. 4. For fastening purposes, a threaded ring 14 is guided over the capsule element 7, wherein the threaded ring 14 can be screwed, supported on the collar 7.1 of the capsule element 7, to an internal thread formed in the valve block 2. For fastening the valve device to the valve block 2, the external thread 22 of the threaded ring 14 is screwed into an internal thread 23 formed in the valve block 2. An axial end face of the threaded ring 14 forms an annular face which bears on the capsule element collar 7.1 at least in regions. The end face of the capsule element collar 7.1 formed in the axial alignment of the capsule element 7 forms a sealing surface with respect to the bearing surface on the valve block 2, wherein a metal bead seal 19, not represented here, as is shown in FIG. 3b, is arranged between the sealing surface of the capsule element collar 7.1 and the bearing surface of the valve block 2. The screw connection exerts a contact pressure of the capsule element collar 7.1 on the bearing surface of the valve block 2. It can be provided that the threaded ring 14 is tightened with a torque of 100 Nm. The resulting force between the capsule element 7 and the valve block 2 compresses the metal bead seal 19, wherein the metal bead seal 19 compensates for surface imperfections in order to seal the valve device from the external environment.

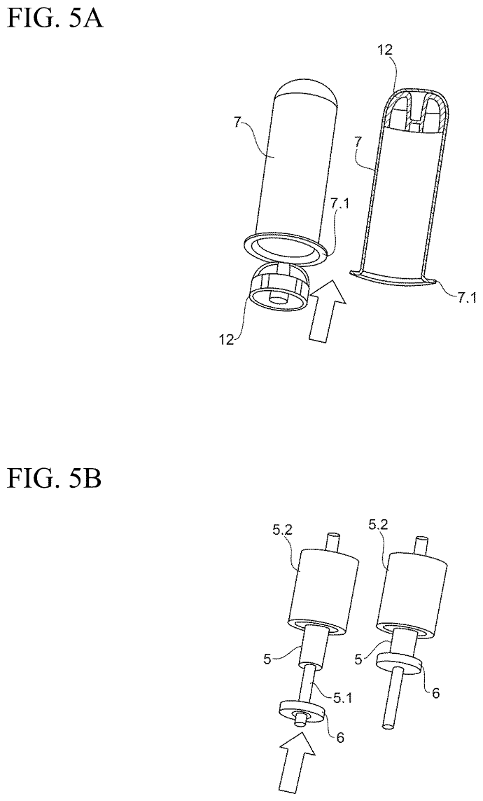

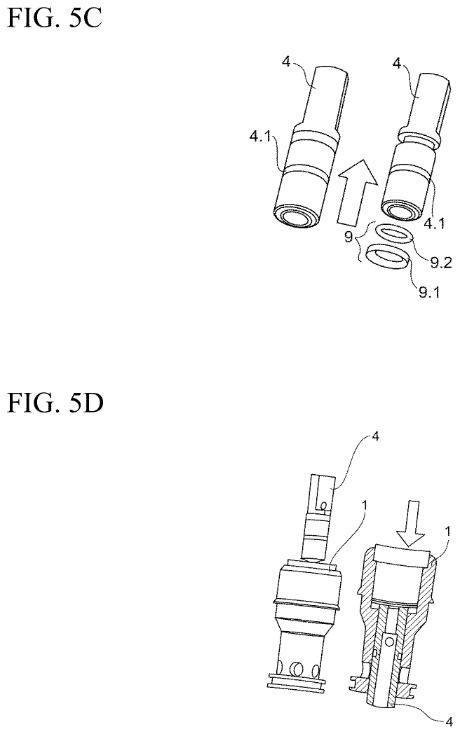

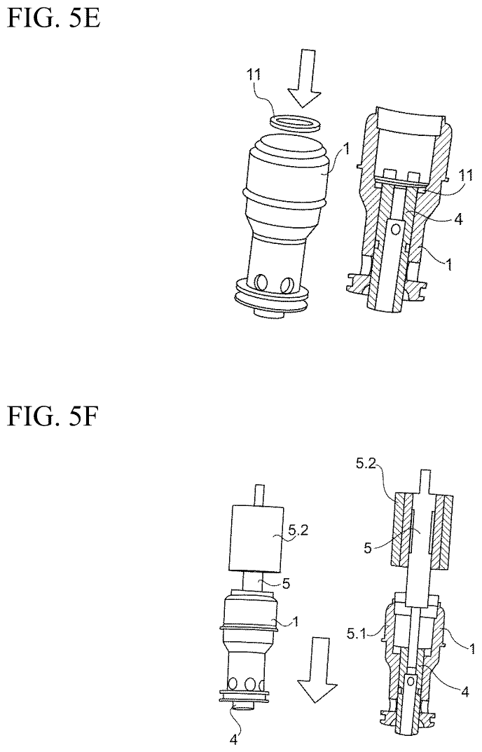

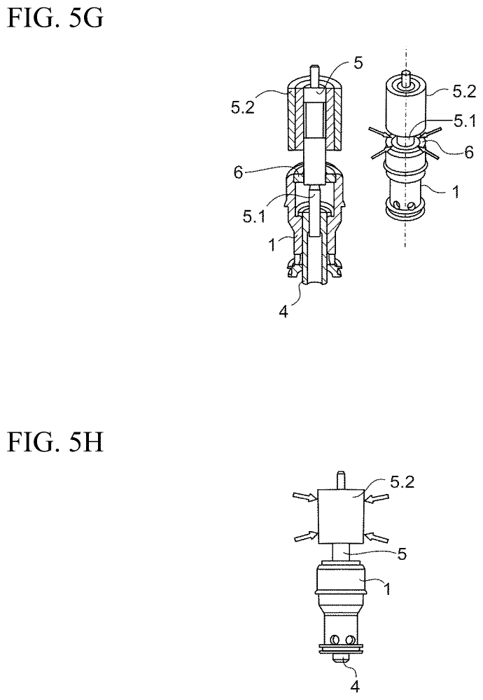

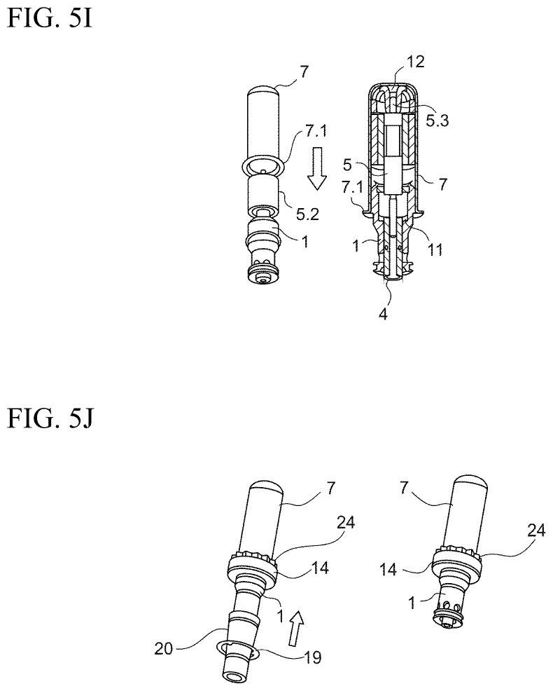

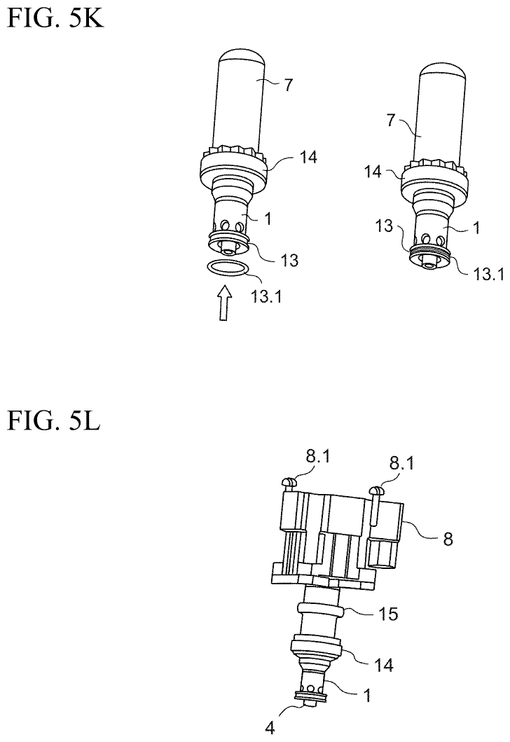

FIGS. 5a to 5l show assembly steps for the assembly of the valve device according to the invention according to the design.

FIG. 5a shows the first assembly step of the valve device according to the invention, wherein the sliding bearing 12 is introduced into the capsule element 7 in such a way that the sliding bearing 12 is arranged at the bottom of the capsule element 7. The sliding bearing 12 is preferably formed from a material with low sliding friction.

FIG. 5b shows a second assembly step of the valve device according to the invention, wherein the ball bearing 6 is positioned on the rotor shaft 5 so that the rotor shaft 5 can be assembled together with the ball bearing 6 as a unit.

FIG. 5c shows an assembly of the combination seal 9 on the valve needle 4. As represented, the assembly is in the arrow direction such that first the O-ring 9.2 is pushed from the lower shank side in the direction of the groove 4.1 and is positioned there. Subsequently, the PTFE-ring 9.1 is pushed over the cylindrical shank of the valve needle 4 and positioned in the groove 4.1 above the O-ring 9.2.

Next, the fourth assembly step of the valve device according to the invention follows, which is represented in FIG. 5d. This step comprises the positioning of the valve needle 4 in the valve body bushing 1. The assembly of the valve needle 4 is in the direction of the arrow.

In the fifth step, which is represented in FIG. 5e, the guide disc 11 is pressed into the valve body bushing 1. The cross-sectional opening of the guide disc 11 receives the shank end of the valve needle 4, so that rotation of the valve needle 4 in the valve body bushing 1 is prevented.

In the following sixth step, which is shown in FIG. 5f, the rotor shaft 5 of the spindle drive, which is pre-assembled in accordance with the second step (FIG. 5b), is combined with the valve body bushing 1 by screwing the threaded shank 5.1 into the internal thread 23 of the valve needle 4.

Further, FIG. 5g shows a seventh assembly step of the valve device according to the invention, wherein the ball bearing 6 is fixed within the valve body bushing 1 by means of edge flanging marked at the arrow positions.

In the following eighth step, which is shown in FIG. 5h, the magnetisation of the magnet 5.2 arranged on the rotor shaft 5 takes place.

A ninth assembly step of the valve device according to the invention is shown in FIG. 5i. In this ninth step, the pre-assembled arrangement shown in FIG. 5h is inserted from the valve body bushing 1 and the spindle drive into the capsule element 7, wherein the insertion depth is limited by the stop rib 1.3 formed on the outer circumference of the valve body bushing 1. As shown in the sectional representation of FIG. 5 i, a part of the rotor shaft 5, namely an upper pin 5.3, is received by the sliding bearing 12, so that the rotor shaft 5 is supported at two positions.

In the following tenth step, which is represented in FIG. 5j, the metal bead seal 19 is positioned on the sealing surface on the end face of the collar 7.1 of the capsule element 7, wherein a protective sleeve 20 is employed for positioning, which is guided over the first axial section 1.1 of the valve body bushing 1. The protective sleeve 20 is removed again after the metal bead seal 19 is positioned. Furthermore, the positioning of the threaded ring 14 takes place, which is pushed over the capsule element 7 and in the process receives the capsule element collar 7.1 or is supported thereon. The threaded ring 14 has engagement elements 24 for a tool. The engagement elements 24 are formed as radially outwardly pointing teeth and serve to transmit force of a torque from a tool to the threaded ring 14 when the threaded ring 14 is screwed into the valve block 2 (not shown).

FIG. 5k shows an eleventh assembly step of the valve device according to the invention, wherein a seal 13.1 in the form of an O-ring is positioned on a groove 13 formed at the head end of the valve body bushing 1.

Finally, the actuator 8 is assembled, as shown in FIG. 5l, by initially guiding a sealing ring 15 over the capsule element 7. The capsule element 7 is then pushed into the actuator 8. The actuator 8 is fastened to a valve block 2 (see FIG. 4) by means of screws 8.1 which are screwed into threads formed in the valve block 2.

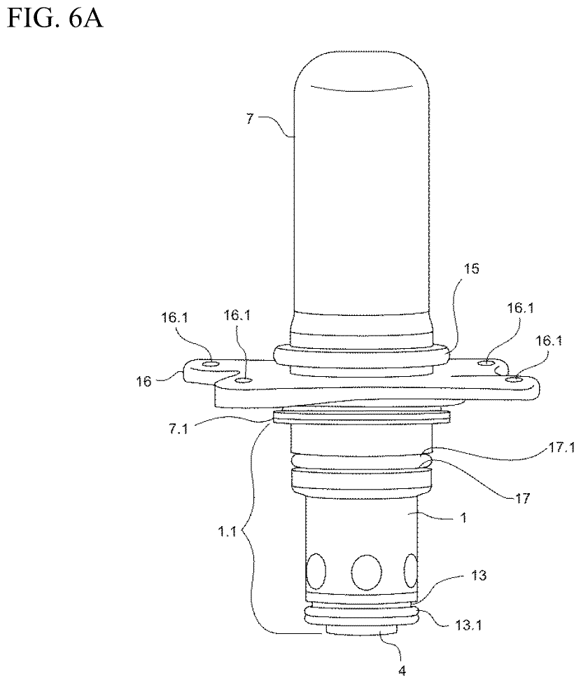

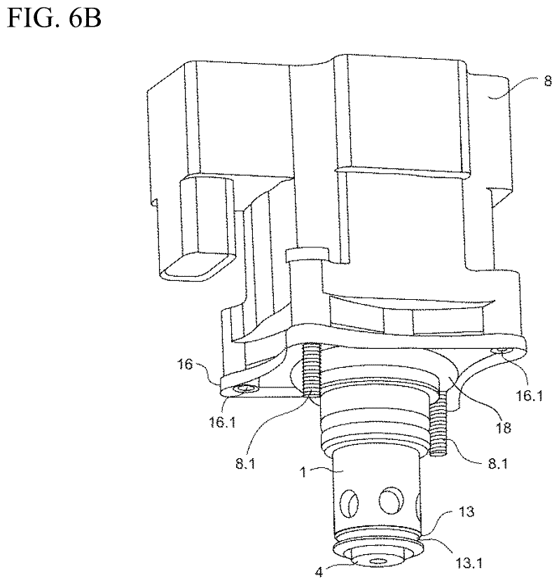

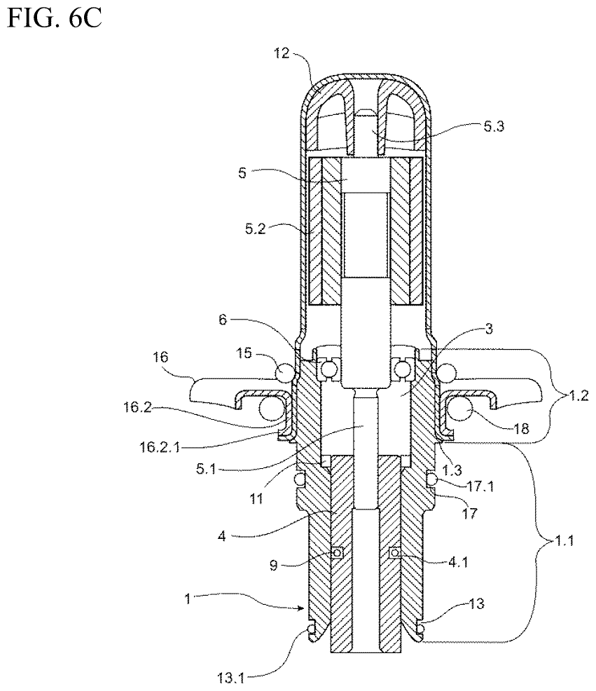

FIG. 6a shows a schematic representation of a design of the valve device according to the invention for operation with the refrigerant R1234yf without the actuator 8 and the valve block 2. The valve device comprises a valve body bushing 1 which has a first axial section 1.1 and a second axial section 1.2, wherein the second axial section 1.2 of the valve body bushing 1 is covered by a capsule element 7 receiving it. The first axial section 1.1 is provided for insertion into a valve block 2 not shown in FIG. 6a. This first axial section 1.1 comprises an upper groove 17 formed at the outer circumference with an upper seal 17.1. A further seal 13.1 is arranged in a further groove 13 formed at the outer circumference at the head end of the valve body bushing 1. A second axial section 1.2 of the valve body bushing 1, which is covered due to the receipt in the capsule element 7, is inserted into the capsule element 7. Furthermore, a spindle drive is received in the capsule element 7 and is coupled to a valve needle 4 guided in the valve body bushing 1 in such a way that a rotation of a rotor shaft 5 of the spindle drive coupled to the valve needle 4, see FIG. 6c, causes an axial movement of the valve needle 4 within the valve body bushing 1. For fastening the valve device to a valve block 2, a fastening plate 16 is provided which is supported on the collar 7.1 of the capsule element 7, wherein four screw passages 16.1 are formed on the outer edge of the fastening plate 16. Screws guided through two diagonally opposite screw passages 16.1 can be screwed into the valve block 2, see FIG. 6 b, in order to fasten the fastening plate 16 to the valve block 2 with the capsule element 7 receiving it. The two remaining diagonally opposite screw passages 16.1, which correspond to the screw passages of the actuator 8, can be used to fix the actuator 8 to the fastening plate 16 by inserting clip elements through the respective corresponding screw passages. Reference numeral 15 designates an actuator seal which is guided as a sealing ring over the capsule element 7.

FIG. 6b shows the design of the valve device according to the invention shown in FIG. 6a from a perspective representation in combination with the actuator 8 in which the capsule element 7 is received. As can be seen, the fastening plate 16 additionally serves as a holder or axial limiting element for the actuator 8. For fastening the actuator 8, the latter has screw passages which correspond to the screw passages 16.1 of the fastening plate 16. Two screws 8.1 can be guided through diagonally opposite screw passages and screwed into a valve block 2, wherein the desired contact pressure for sealing the valve arrangement according to the invention from the environment is achieved. It can be provided that the actuator 8 is positioned fixed on the fastening plate 16 with clip elements, wherein the clip elements are inserted through two diagonally opposite screw passages of the actuator 8 into corresponding screw passages 16.1 of the fastening plate 16. The clip elements fix the actuator 8 to the fastening plate 16 so that the actuator 8 and the fastening plate 16 together with the capsule element 7 received therein form a component unit even before assembly with the valve block 2.

On the surface facing the valve block 2, the fastening plate 16 has a stub on which a corrosion protection ring 18 is positioned.

FIG. 6c shows a sectional representation of the valve device according to the invention for operation with the refrigerant R1234yf. The valve device has a valve body bushing 1 with a valve body chamber 3 formed therein, in which a valve needle 4 is guided so as to be axially movable back and forth. The back and forth movement is carried out with a spindle drive which comprises a magnetised rotor shaft 5 which is supported by an anti-friction bearing 6 received in the valve body bushing 1. In this case, a threaded shank 5.1 of the rotor shaft 5 is screwed into an internal thread of the valve needle 4, so that a rotation of the rotor shaft 5 causes an axial movement of the valve needle 4 in the valve body bushing 1, depending on the direction in which the rotor shaft 5 rotates.

Arranged at the bottom of the capsule element 7 is a sliding bearing 12 which supports a pin 5.3 of the rotor shaft 5. Thus, the rotor shaft is supported by the ball bearing 6 and the sliding bearing 12. Furthermore, the rotor shaft 5 has a magnet 5.2 by means of which the rotor shaft 5 can be set in rotation movement from outside by the activity of an actuator 8 which is not shown here.

The valve body bushing 1 has a first axial section 1.1 and a second axial section 1.2. The valve needle 4 is received in the first axial section 1.1. The first axial section 1.1 is provided for insertion into a valve block 2, not represented here, for which reason this part projects out of the capsule element 7. The second axial section 1.2 of the valve body bushing 1 is received inserted into the capsule element 7, wherein the axial insertion depth of the valve body bushing 1 is limited by a stop rib 1.3 formed on the outer circumference of the valve body bushing 1. The valve needle 4 has a circumferential groove 4.1 in which the combination seal 9, as shown in FIG. 2, is arranged.

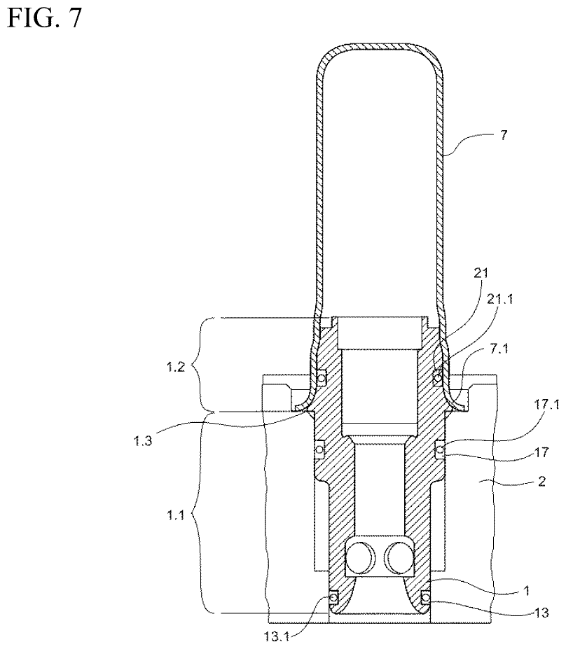

In the first axial section 1.1, the valve body bushing 1 has an upper groove 17 running around the outer circumference with an upper seal 17.1 in the form of an O-ring. This upper seal 17 serves for the upper sealing of the valve body bushing 1 with respect to the valve block 2. Furthermore, a circumferential groove 13 is formed at the head end of the valve body bushing 1, wherein a sealing ring 13.1 is arranged in the groove 13. The sealing ring 13.1 also serves to seal the valve body bushing 1 with respect to the valve block 2. The cooperation of the outer circumferential sealing rings 13.1 and 17.1 of the valve body bushing 1 with the valve block 2 when the first axial section 1.1 is inserted into the valve block 2 can be understood with FIG. 7.

On the side facing the valve block 2, the fastening plate 16 has a support stub 16.2 which extends out of the opening of the fastening plate 16 receiving the capsule element 7. The end face of the support stub 16.2 is formed to bear on the capsule element collar 7.1. In this case, the support stub 16.2 also has a radially outwardly directed collar 16.2.1, the collar end face of which bears on the capsule element collar 7.1 in a form-fitting manner.

The support stub 16.2 receives a corrosion protection element 18 in the form of a corrosion protection ring. A sealing ring 15 surrounding the capsule element 7 is arranged on the side of the fastening plate 16 facing the valve block 2.

FIG. 7 shows a schematic sectional representation of the valve device with the components of the capsule element 7 and the valve body bushing 1 in operative connection with a valve block 2. In this representation, the further components of the valve needle 4, the spindle drive and the fastening plate 16 are not represented for better illustration. In this design, the second axial section 1.2 of the valve body bushing 1 has an additional groove 21 on the outer circumference with a sealing ring 21.1 which is provided for sealing the valve body bushing 1 with respect to that of the receiving capsule element 7. The capsule element 7, which receives the second axial section 1.2 of the valve body bushing 1, bears with the end face formed by the collar 7.1 on a countersunk hole surface formed in the valve block 2, so that the first axial section 1.1 of the valve body bushing 1 is arranged within a stepped bore formed in the valve block 2. The axial depth of insertion into the capsule element 7 is limited by the stop rib 1.3 formed on the outer circumference of the valve body bushing 1. Thus, the axial insertion depth corresponds to the length of the second axial section 1.2. The stop rib 1.3 and the end face of the collar 7.1 together form a contact surface for contact with the valve block 2. In the first axial section 1.1, the upper shank end of the valve body bushing 1 has an upper groove 17 running around the outer circumference with an upper seal 17.1 in the form of an O-ring. Furthermore, a circumferential groove 13 is formed at the head end of the valve body bushing 1, wherein a sealing ring 13.1 is arranged in the groove 13.

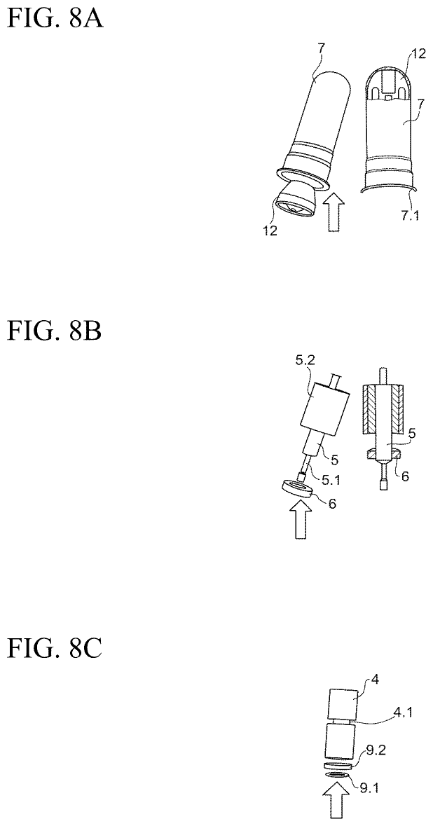

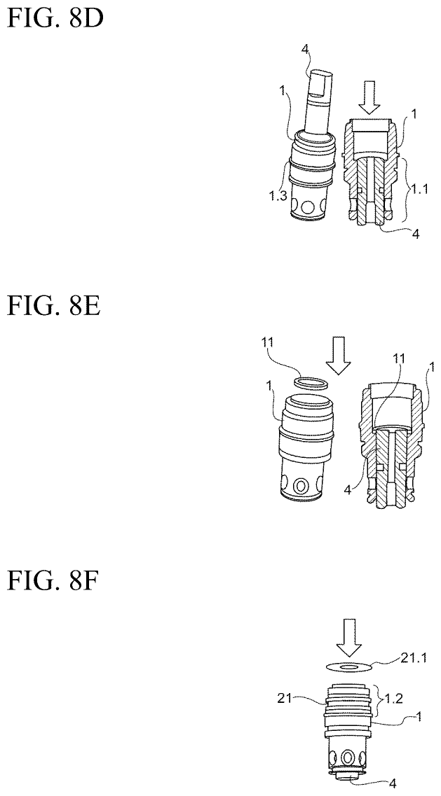

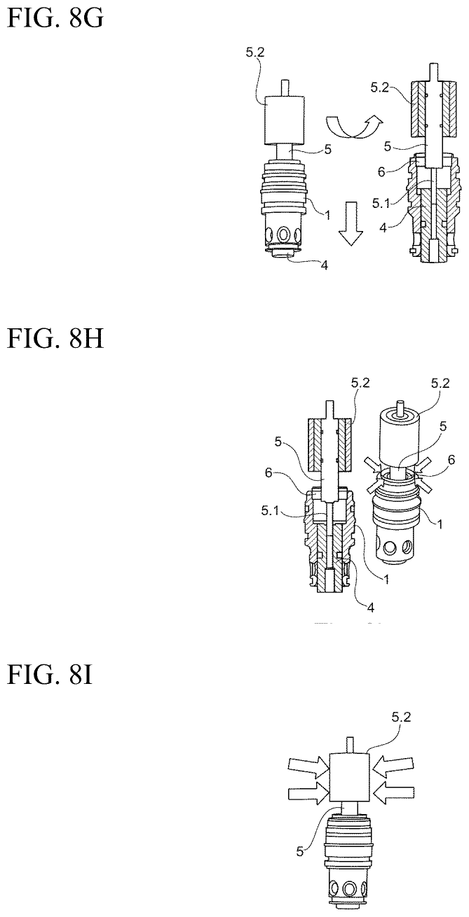

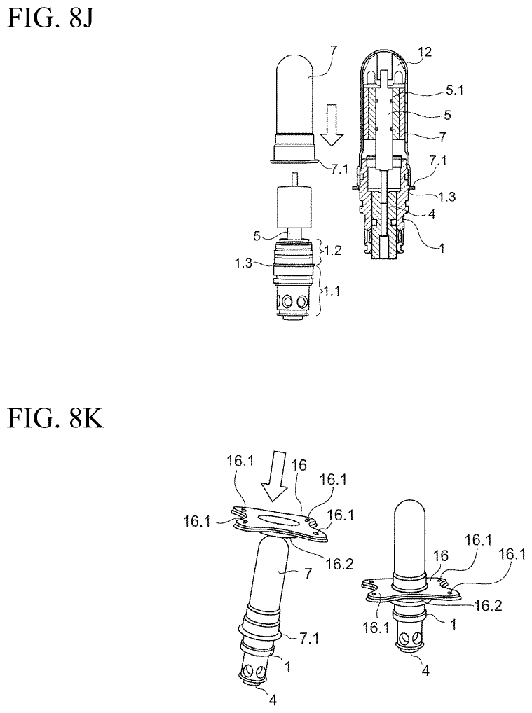

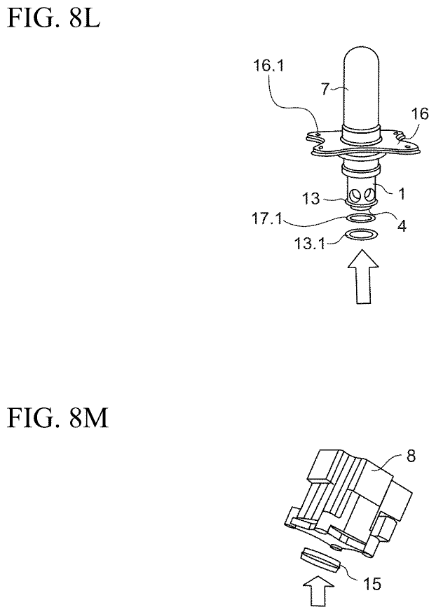

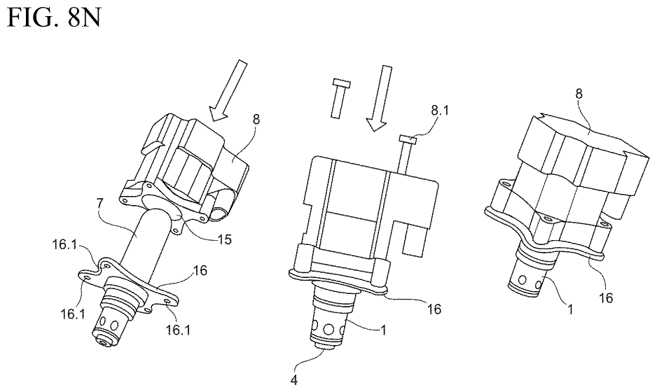

FIGS. 8a to 8n show schematic representations of assembly steps for assembling the design of the valve device according to the invention shown in FIG. 7.

In the first step, which is shown in FIG. 8a, a sliding bearing 12 is inserted into a capsule element 7 and positioned on the capsule element bottom, as shown in the sectional representation.

In the second step, which is shown in FIG. 8b, a ball bearing 6 is positioned on the rotor shaft 5. FIG. 8c shows the third assembly step, wherein a combination seal consisting of an O-ring 9.2 and a PTFE-ring 9.1 is positioned on the valve needle 4 in a groove 4.1 formed on the outer circumference. The O-ring 9.2 is first placed in the groove 4.1 and then the PTFE-ring 9.1 is arranged above the O-ring 9.2 in the groove 4.1, so that the PTFE-ring 9.1 is directed radially outwards.

Further, FIG. 8d shows a fourth assembly step, wherein the valve needle 4 is pushed into the valve body bushing 1 in the direction of the arrow and is positioned in the first axial section 1.1 of the valve body bushing 1. Reference numeral 1.3 designates the stop rib on the valve body bushing 1.

In the following, as shown in FIG. 8e, a guide disc 11 is pressed into the valve body bushing 1 in such a way that the cross-section of the upper shank of the valve needle 4 is received by the opening cross-section of the guide disc 11 in order to avoid rotation of the valve needle 4 within the valve body bushing 1. The arrangement of the press fit of the guide disc 11 within the valve body bushing 1 is shown in the sectional representation of the valve body bushing 1 in FIG. 8e. The following sixth step is shown in FIG. 8f. This step is provided in order to arrange a sealing ring 21.1 in the form of an O-ring in a groove 21 formed in the second axial section 1.2. The arrangement follows from the direction of the second axial section 1.2 in the arrow direction.

FIG. 8g shows a seventh assembly step, wherein the pre-assembled rotor shaft 5 shown in FIG. 8b is assembled with the valve needle 4 of the valve body bushing 1. The assembly is effected by screwing the threaded shank 5.1 of the rotor shaft 5 into an internal thread of the valve needle 4. In this process, the ball bearing 6 is positioned on a bearing seat formed in the valve body bushing 1.

As shown in FIG. 8h, the ball bearing 6 positioned in the valve body bushing 1 is fixed at the arrow positions by edge flanging of the upper edge of the valve body bushing 1 in order to avoid rotation or displacement.

As the next step, which is shown in FIG. 8 i, a magnetisation of the magnet 5.2 formed on the rotor shaft 5 can be provided. This method step is not absolutely necessary at this point and can be carried out at another position in the assembly sequence.

FIG. 8j shows a tenth method step for assembly of the valve device according to the invention, wherein the valve component arrangement pre-assembled from the components of the spindle drive and the valve body bushing 1 is received in the capsule element 7. As shown in the sectional representation, the end of the rotor shaft 5 is received by the sliding bearing 12 which is arranged on the bottom of the capsule element, so that the rotor shaft 5 is then rotatably supported by two bearing positions. The insertion depth of the valve body bushing 1 is up to the circumferentially formed stop rib 1.3, so that the first axial section 1.1 of the valve body bushing 1 projects out of the capsule element 7.

FIG. 8k shows the eleventh assembly step, wherein the fastening plate 16 is guided over the capsule element 7. For this purpose, the fastening plate 16 has a centrally formed opening which has, on the side facing the valve block 2, a support stub 16.2 which is provided for the bearing or support of the fastening plate 16 on the collar 7.1 of the capsule element 7. The support stub 16.2 additionally serves as a spacer element and for the transmission of force.

Further, FIG. 8l shows a twelfth assembly step of the valve device according to the invention, wherein seals 13.1 and 17.1 in the form of O-rings are arranged in the first axial section 1.1 in the grooves 13 and 17 provided for this purpose.

Next, as shown in FIG. 8m, a sealing ring 15 is inserted in a formation of the actuator 8 receiving the capsule element 7. Finally, the fourteenth method step is represented in FIG. 8n, which shows the receipt of the capsule element 7 in a formation of the actuator 8. It becomes clear that the fastening plate 16 additionally serves as a stop plate or holder for the actuator 8. The actuator 8 has screw passages which correspond to the screw passages 16.1 of the fastening plate 16, so that screws 8.1 can be screwed into the valve block 2 through the screw passages of the actuator 8 and the screw passages 16.1 of the fastening plate 16.

### INDUSTRIAL APPLICABILITY

The invention relates to a valve device for operation with a refrigerant, in particular for operation in a heat pump system of a motor vehicle air conditioning system, in which carbon dioxide, CO2 (R744) or 2,3,3,3-tetrafluoropropene (R1234yf) is used as refrigerant.

1-18. (canceled)

19. A valve device for operation with a refrigerant in a motor vehicle heat pump system, the valve device comprising:
a valve body bushing with a first axial section provided for insertion into a valve block, in which a valve body chamber with a valve needle guided axially therein is formed,
a spindle drive with a magnetized rotor shaft, which is supported by an anti-friction bearing and coupled to the valve needle in such a way that a rotation of the rotor shaft causes an axial movement of the valve needle in the valve body bushing, and
a capsule element which has an opening formed on one side, in which the spindle drive and a second axial section of the valve body bushing are received, wherein the capsule element can be fastened to the valve block by means of an actuator receiving it for driving the rotor shaft in such a way that the first axial section is received in the valve block in a fluid-tight manner.

20. The valve device according to claim 19, wherein the opening of the capsule element has a stepped edge in a form of a capsule element collar pointing radially outwards, which cooperates with a superposed sleeve element for fastening the capsule element.

21. The valve device according to claim 20, wherein the sleeve element is a threaded ring with an external thread which, for fastening the capsule element, is guided over the capsule element and, supported on the capsule element collar of the capsule element, can be screwed to an internal thread formed in the valve block, wherein a seal is arranged between an axially aligned end face of the capsule element collar and the valve block.

22. The valve device according to claim 20, wherein a fastening plate with at least two screw passages can be used as the sleeve element, which is guided over the capsule element for fastening the capsule element and, supported on the capsule element collar, can be screwed to the valve block, wherein a corrosion protection element is arranged between the fastening plate and the valve block.

23. The valve device according to claim 22, wherein the fastening plate serves as a holder for fastening the actuator.

24. The valve device according to claim 19, wherein the anti-friction bearing is received in the valve body bushing and is fixed by edge flanging.

25. The valve device according to claim 19, wherein the capsule element has a sliding bearing which serves as an additional bearing for the rotor shaft.

26. The valve device according to claim 19, wherein the valve body bushing has a stop rib which is formed on an outer circumference and which limits an axial insertion depth into the capsule element.

27. The valve device according to claim 19, wherein the valve needle has at least one groove which is formed on an outer circumference and has a seal for internal sealing with respect to the valve body bushing.

28. The valve device according to claim 27, wherein the seal is formed as a combination seal with an O-ring and a PTFE-ring which is arranged on the O-ring and points radially outwards.

29. The valve device according to claim 19, wherein the valve body bushing in the first axial section has at least one groove which is formed on an outer circumference and has a seal for internal sealing with respect to the valve block.

30. The valve device according to claim 19, wherein the valve body bushing has different shank diameters in the first axial section, wherein each of the different shank diameters has at least one groove which is formed on an outer circumference and has a seal for internal sealing with respect to the valve block.

31. The valve device according to claim 19, wherein the valve body bushing in the second axial section has at least one groove which is formed on an outer circumference and has a sealing ring for internal sealing with respect to the capsule element.

32. The valve device according to claim 19, wherein a guide disc is pressed into the valve body bushing, and wherein the guide disc has an opening cross-section which receives the valve needle and axially guides the valve needle.

33. The valve device according to claim 19, wherein a seal in a form of a sealing ring is arranged between the capsule element and the actuator.

34. The valve device according to claim 19, wherein the valve body bushing and the valve needle are formed in such a way that there is a pressure bypass to the valve body chamber in a closed state of the valve device.

35. The valve device according to claim 34, wherein when the refrigerant is R744, and a free diameter for pressure equalization in the pressure bypass is increased.

36. The valve device according to claim 35, wherein a diameter of the valve needle is dimensioned smaller for use with the R744 than for use with the refrigerant being R1234yf or R134a.
